(19) United States
(12) Patent Application Publication
(10) Pub. No.: US 2001/0004353 A1
(43) Pub. Date: Jun. 21, 2001

(54) High frequency composite component and mobile communication apparatus incorporating the same

(75) Inventors: Koji Furutani, Okayama-shi (JP); Koji Tanaka, Shiga-ken (JP); Takahiro Watanabe, Shiga-ken (JP); Hidcki Muto, Takcfu-shi (JP); Takanori Uejima, Okayama-ken (JP); Norio Nakajima, Takatsuki-shi (JP)

Correspondence Address: Keating & Bennett LLP, Suite 312, 10400 Eaton Place, Fairfax, VA, 22030, US

(73) Assignee: Murata Manufacturing Co., Ltd, Nagaokakyo-shi (JP)

(21) Appl. No.: 09/742,455

(22) Filed: Dec. 21, 2000

(30) Foreign Application Priority Data
Dec. 21, 1999 (JP) 11-363324

(51) Int. Cl. H04L 5/14

(52) U.S. Cl. 370/297; 370/276

(57) ABSTRACT

A high frequency composite component is miniaturized and included in a mobile communication apparatus. The high frequency composite component includes a diplexer, a duplexer, and a high frequency switch. The diplexer is defined by first inductors and first capacitors. The duplexer is defined by second inductors and second capacitors, and the high frequency switch is defined by a first diode and a second diode, third inductors, and third capacitors.

### BACKGROUND OF THE INVENTION

1. Field of the Invention

The present invention relates to high frequency composite components and mobile communication apparatuses, and more particularly, it relates to high frequency composite components and mobile communication apparatuses usable in a plurality of different mobile communication systems.

2. Description of the Related Art

Currently, in North America, mobile communication apparatus include dual-band mobile phones that use both the technique of CDMA (Code Division Multiple Access) represented by AMPS (Advanced Mobile Phone Services) using the band of 880 MHz and the technique of TDMA (Time Division Multiple Access) represented by PCS (Personal Communication Services) using the band of 1.9 GHz.

FIG. 8 is a block diagram showing a portion of the structure of a conventional dual-band mobile phone. This is an example of the combination of AMPS of the 880-MHz band and PCS of the 1.9-GHz band. A dual-band mobile phone 50 has an antenna 51, a diplexer 52, and two signal paths including the systems of AMPS and PCS.

The diplexer 52 distributes signals received via the antenna 51 to the AMPS system or the PCS system and transmits signals sent from the AMPS system or the PCS system to the antenna 51. The AMPS system includes a duplexer 53 as a unit for dividing transmitted/received signals of the AMPS system to send to a transmission section Txa and a reception section Rxa. The PCS system includes a duplexer 54 as a unit for dividing transmitted/received signals of the PCS system to send to a transmission section Txp and a reception section Rxp.

Now, the operation of the dual-band mobile phone 50 will be illustrated below by using an example of the AMPS system. During transmission, the diplexer 52 selects a signal from the transmission section Txa selected by the duplexer 53 to transmit the signal from the antenna 51. During reception, a signal received by the antenna 51 is transmitted to the AMPS system selected by the diplexer 52, and the signal is further transmitted to the reception section Rxa after the duplexer 53 selects the reception section Rxd. In addition, in the case of the PCS system, a similar operation is performed for transmission/reception.

In the above conventional dual-band mobile phone, the front-end section thereof is defined by a diplexer and two duplexers. However, it is necessary to make the attenuation characteristics of the duplexer sharper when the frequency band of a transmitted signal is near the frequency band of a received signal. In order to do so, the size of the duplexer must be increased. As a result, there is a problem in that the size of the dual-band mobile phone (a mobile communication apparatus) is increased.

### SUMMARY OF THE INVENTION

In order to overcome the problems described above, preferred embodiments of the present invention provide a high frequency composite component capable of being miniaturized and a mobile communication apparatus incorporating such a high frequency composite component.

According to a preferred embodiment of the present invention, there is provided a high frequency composite component constituting a portion of a front-end section in a mobile communication apparatus for CDMA/TDMA common systems. The high frequency composite component includes a diplexer arranged to distribute a signal received via an antenna to a CDMA signal path or a TDMA signal path and to transmit a signal from the CDMA signal path or the TDMA signal path to the antenna, a duplexer disposed in the rear stage of the diplexer to divide the CDMA signal path into a transmission section and a reception section, and a high frequency switch disposed in the rear stage of the diplexer to divide the TDMA signal path into a transmission section and a reception section.

In addition, this high frequency composite component may further include a high frequency filter, which is connected to at least one of a location between the diplexer and the high frequency switch, the transmission section in the rear stage of the high frequency switch, and the reception section in the rear stage of the high frequency switch.

In addition, at least the diplexer, the duplexer, and the high frequency switch may be defined by a multi-layer substrate including a plurality of dielectric layers laminated.

According to another preferred embodiment of the present invention, a mobile communication apparatus includes an antenna, a transmission section, a reception section, and the above-described high frequency composite component.

In the high frequency composite component of a preferred embodiment of the present invention constituting a portion of the front-end section defined by the CDMA/TDMA common systems, switching between transmission/reception of the TDMA side is performed by the high frequency switch. As a result, the high frequency composite component can be miniaturized.

In the mobile communication apparatus of preferred embodiments of the present invention, since the compact high frequency composite component is incorporated therein, the front-end section in the mobile communication apparatus for CDMA/TDMA common systems can be miniaturized.

Other features, elements, characteristics and advantages of preferred embodiments of the present invention will become apparent from the following detailed description of preferred embodiments thereof with reference to the attached drawings.

### BRIEF DESCRIPTION OF THE DRAWINGS

FIG. 1 is a block diagram of a high frequency composite component according to a first preferred embodiment of the present invention;

FIG. 2 is a circuit diagram of a diplexer defining the high frequency composite component shown in FIG. 1;

FIG. 3 is a circuit diagram of a duplexer defining the high frequency composite component shown in FIG. 1;

FIG. 4 is a circuit diagram of a high frequency switch defining the high frequency composite component shown in FIG. 1;

FIG. 5 is a partial exploded perspective view showing the detailed structure of the high frequency composite component shown in FIG. 1;

FIG. 6 is a block diagram of a high frequency composite component according to a second preferred embodiment of the present invention;

FIG. 7 is a circuit diagram of a high frequency filter defining the high frequency composite component shown in FIG. 6; and

FIG. 8 is a block diagram showing a portion of the structure of a conventional dual-band mobile phone (a mobile communication apparatus).

### DETAILED DESCRIPTION OF PREFERRED EMBODIMENTS

Now, a description will be given of various preferred embodiments of the present invention with reference to the drawings.

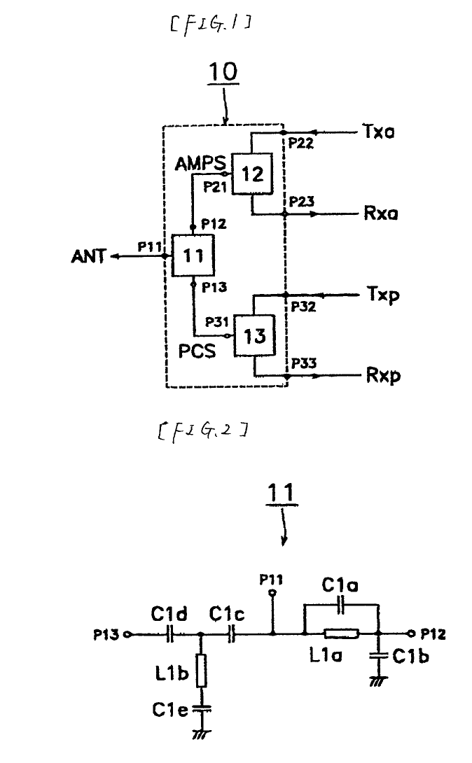

FIG. 1 shows a block diagram of a high frequency composite component according to a first preferred embodiment of the present invention. A high frequency composite component 10 preferably includes a diplexer 11, a duplexer 12 included in the AMPS system of the CDMA technique and a high frequency switch 13 included in the PCS system of the TDMA technique. A portion surrounded by a broken line is defined by a multi-layer substrate (not shown).

Additionally, a first port P11 of the diplexer 11 is connected to an antenna ANT, a second port P12 thereof is connected to a first port P21 of the duplexer 12 of the AMPS system, and a third port P13 thereof is connected to a first port P31 of the high frequency switch 13 of the PCS system.

Further, in the AMPS system, the second port P22 of the duplexer 12 is connected to a transmission section Txa, and the third port P23 thereof is connected to a reception section Rxa.

In addition, in the PCS system, a second port P32 of the high frequency switch 13 is connected to a transmission section Txp, and a third port P33 thereof is connected to a reception section Rxp.

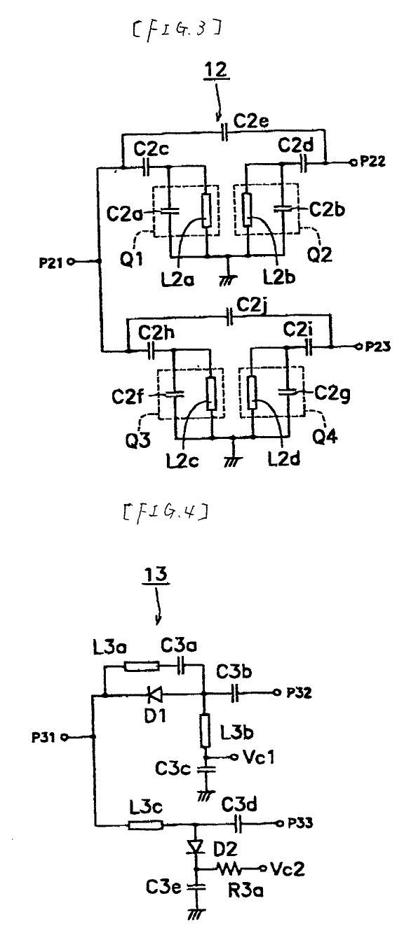

FIG. 2 shows a circuit diagram of the diplexer defining the high frequency composite component shown in FIG. 1. The diplexer 11 preferably includes inductors L1a and L1b, and capacitors C1a to C1e.

A parallel circuit including the inductor L1a and the capacitor C1a is connected between the first port P11 and the second port P12. The second port P12 of the parallel circuit is connected to a ground via the capacitor C1b.

The capacitors C1c and C1d are connected in series between the first port P11 and the third port P13. The junctions of the capacitors C1c and C1d are connected to a ground via the inductor L1b and the capacitor C1e.

In other words, a low pass filter is defined between the first port P11 and the second port P12, and a high pass filter is provided between the first port P11 and the third port P13.

In this case, the low pass filter provided between the first port P11 and the second port P12 allows only transmitted/received signals of the AMPS system (low frequency band side) connected to the second port P12 to pass through. The high pass filter defined between the first port P11 and the third port P13 allows only transmitted/received signals of the PCS system (high frequency band side) connected to the third port P13.

FIG. 3 shows a circuit diagram of the duplexer defining the high frequency composite component shown in FIG. 1. The duplexer 12 preferably includes inductors L2a to L2d and capacitors C2a to C2j.

Between the first port P21 and the second port P22 are provided a resonator Q1 defined by the inductor L2a and the capacitor C2a connected in parallel to each other and a resonator Q2 defined by the inductor L2b and the capacitor C2b connected in parallel to each other. In this situation, the inductor L2a of the resonator Q1 and the inductor L2b of the resonator Q2 are coupled to each other with the magnetic coupling degree M.

One end of the resonator Q1 is connected to the first port P21 via the capacitor C2c, and the other end thereof is connected to a ground. Additionally, one end of the resonator Q2 is connected to the second port P22 via the capacitor C2d, and the other end thereof is connected between the first port P21 and the second port P22.

Between the first port P21 and the third port P23, a resonator Q3 defined by the inductor L2c and the capacitor C2f connected in parallel to each other, and a resonator Q4 defined by the inductor L2d and the capacitor C2g connected in parallel to each other. In this situation, the inductor L2c of the resonator Q3 and the inductor L2d of the resonator Q4 are coupled to each other with a magnetic coupling degree M.

One end of the resonator Q3 is connected to the first port P21 via the capacitor C2h, and the other end thereof is connected to a ground. In addition, one end of the resonator Q4 is connected to the third port P23 via the capacitor C2i, and the other end thereof is connected to a ground. The capacitor C2j is connected between the first port P21 and the third port P23.

In other words, band pass filters are provided between the first port P21 and the second port P22 and between the first port P21 and the third port P23. In this situation, the band pass filter provided between the first port P21 and the second port P22 enables the passing of only signals transmitted from the transmission section Txa connected to the second port P22. The band pass filter provided between the first port P21 and the third port P23 enables the passing of only signals received by the reception section Rxa connected to the third port P23.

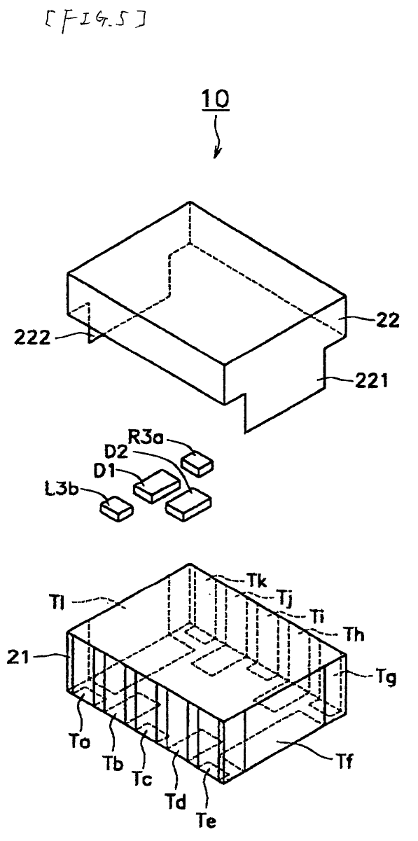

FIG. 4 shows a circuit diagram of the high frequency switch defining the high frequency composite component shown in FIG. 1. The high frequency switch 13 preferably includes diodes D1 and D2, inductors L3a to L3c, capacitors C3a to C3e, and a resistor R3a. The inductor L3a is preferably a parallel trap coil, and the inductor L3b is preferably a choke coil.

The diode D1 is connected between the first port P31 and the second port P32 in such a manner that the cathode of the diode D1 is oriented toward the first port P31. The diode D1 is connected in parallel to a series circuit including the inductor L3a and the capacitor C3a.

The other side of the diode D1, is oriented toward the second port P32, that is, the anode thereof is connected to the second port P32 via the capacitor C3b, and is also connected to a ground via the inductor L3b and the capacitor C3c. In addition, a control terminal Vc1 is connected to a junction of the inductor L3b and the capacitor C3c.

The inductor L3c and the capacitor C3d are connected in series between the first port P31 and the third port P33. A junction of the inductor L3c and the capacitor C3d is connected to a ground via the diode D2 and the capacitor C3e. In addition, a control terminal Vc2 is connected to a junction of the cathode of the diode D2 and the capacitor C3e via the resistor R3a.

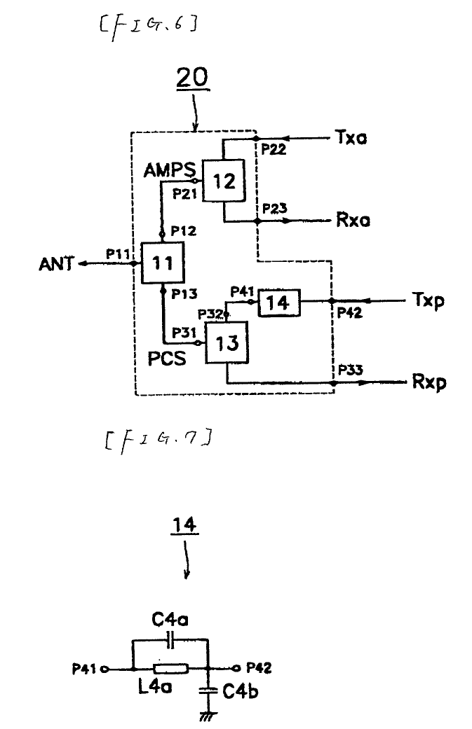

FIG. 5 shows a partial exploded perspective view showing the detailed structure of the high frequency composite component shown in FIG. 1. A high frequency composite component 10 includes a multi-layer substrate 21. The multi-layer substrate 21 contains the inductors L1a and L1b, and the capacitors C1a to C1e defining the diplexer 11 (shown in FIG. 2), the inductors L2a to L2d and the capacitors C2a to C2j defining the duplexer 12 (shown in FIG. 3), and the inductors L3a and L3c, and the capacitors C3a to C3e defining the high frequency switch 13 (shown in FIG. 4), which are not shown in FIG. 5.

In this situation, the inductors L1a, L1b, L2a to L2d, L3a, and L3c are defined by stripline electrodes located inside the multi-layer substrate 21. The capacitors C1a to C1e, C2a to C2j, and C3a to C3e are defined by capacitor electrodes located inside of the multi-layer substrate 21, or the capacitor electrodes and ground electrodes. Consequently, the inductors L1a, L1b, L2a to L2d, L3a, and L3c and the capacitors C1a to C1e, C2a to C2j, and C3a to C3e are contained inside the multi-layer substrate 21.

In addition, on the surface of the multi-layer substrate 21 are mounted the diodes D1 and D2 defining the high frequency switch 13 (shown in FIG. 4) including a chip component, the inductor (a choke coil) L3b, and the resistor R3a.

In addition, from the side surfaces of the multi-layer substrate 21 to the bottom thereof, twelve external terminals Ta to Tl are preferably provided and formed by screen printing or other suitable process. These external terminals Ta to Tl are used as the first port P11 of the diplexer 11, the second port P22 and the third port P23 of the duplexer 12, the second port P32, the third port P33, and the control terminals Vc1 and Vc2 of the high frequency switch 13, and ground terminals.

Furthermore, a metal cap 22 is disposed over the multi-layer substrate 21 to cover the elements mounted thereon in such a manner that protrusions 221 and 222 of opposing shorter edges of the metal cap 22 abut the external terminals Tf and Tl defining ground terminals.

Inside the multi-layer substrate 21, the second port P12 of the diplexer 11 is connected to the first port P21 of the duplexer 12, and the third port P13 of the diplexer 11 is connected to the first port P31 of the high frequency filter 13.

Now, the operation of the high frequency composite component 10 having the structure shown in FIG. 1 will be illustrated. First, when a signal of the AMPS system (880 MHz band) is transmitted, the transmitted signal of the AMPS system passes through the duplexer 12 and the diplexer 11, and is sent from an antenna ANT connected to the first port P11 of the diplexer 11.

In this case, with the band pass filter connected between the first port P21 and the third port P23 of the duplexer 12, arrangement is made such that a transmitted signal does not enter the reception section Rxa. Additionally, with the high band pass filter connected between the first port P11 and the third port P13 of the diplexer 11, arrangement is made such that a transmitted signal of the AMPS system does not enter the PCS system.

Next, when a signal of the PCS system (900 MHz band) is transmitted, the high frequency switch 13 of the PCS system turns on the diode D1 by applying a control voltage 3V to the control terminal Vc1 (shown in FIG. 4). With this arrangement, the transmitted signal of the PCS system passes through the high frequency switch 13 and the diplexer 11, and then, is transmitted from the antenna ANT connected to the first port P11 of the diplexer 11.

In this situation, the high frequency switch 13 turns on the diode D2 by applying 0V to the control terminal Vc2 (shown in FIG. 4) so that the transmitted signal does not enter the reception section Rx. Furthermore, with the low band pass filter connected between the first port P11 and the second port P12 of the diplexer 11, arrangement is made such that the transmitted signal of the PCS system does not enter the AMPS system.

Next, when signals of the AMPS system and the PCS system are received, the band pass filter connected between the first port P21 and the second port P22 of the duplexer 12 allows the received signal of the AMPS system not to enter the transmission section Txa. The PCS high frequency switch 13 turns off the diodes D1 and D2 by applying 0V to the control terminal Vc1 and applying a control voltage 3V to the control terminal Vc2. This arrangement permits the PCS received signal to be sent only to the PCS reception section Rxp and prevents the received signal from entering the PCS transmission section Txp.

In addition, similar to the case of transmission, the diplexer 11 prevents the AMPS received signal from entering the PCS system and also prevents the PCS received signal from entering the AMPS system.

In the high frequency composite component of the first preferred embodiment, switching between transmission/reception in the PCS system of TDMA is performed by the compact high frequency switch having fewer elements than the duplexer. Thus, the high frequency composite component can be miniaturized. As a result, a mobile communication apparatus incorporating the high frequency composite component can also be miniaturized.

In addition, the diplexer, the duplexer, and the high frequency switch, which constitute the high frequency composite component, are defined by a multi-layer substrate including a plurality of ceramic sheet layers laminated together. Thus, connections of the diplexer, the duplexer, and the high frequency switch are located inside of the multi-layer substrate. As a result, there is no need for a matching circuit to perform matching adjustments between the diplexer and the duplexer, and matching adjustments between the diplexer and the high frequency switch. Accordingly, further miniaturization of the high frequency composite component can be achieved.

Furthermore, losses caused by wiring between elements are minimized, since the diplexer and the duplexer are defined by inductors and capacitors, and the high frequency switch includes diodes, inductors, and capacitors. In addition, the diplexer, the duplexer, and the high frequency switch are contained or mounted in the multi-layer substrate and are connected to each other by connection units provided inside the multi-layer substrate. Thus, loss in the overall high frequency composite component is also greatly reduced. Accordingly, at the same time, the mobile communication apparatus incorporating the high frequency composite component can have high performance capabilities.

In addition, since stripline electrodes used as inductors are contained in the multi-layer substrate, wavelength-shortening effects permit the stripline electrodes as inductors to be shortened. Thus, insertion losses of the stripline electrodes are greatly reduced, and miniaturization and loss reduction of the high frequency composite component can thereby be achieved. As a result, at the same time, the size of the mobile communication apparatus incorporating the high frequency composite component can be reduced while obtaining high performance capabilities.

FIG. 6 is a block diagram of the high frequency composite component according to a second preferred embodiment of the present invention. In a high frequency composite component 20, unlike the high frequency composite component 10 of the first preferred embodiment (shown in FIG. 1), a high frequency filter 14 is connected to a transmission section Txp of the rear stage of a high frequency switch 13 included in the PCS system.

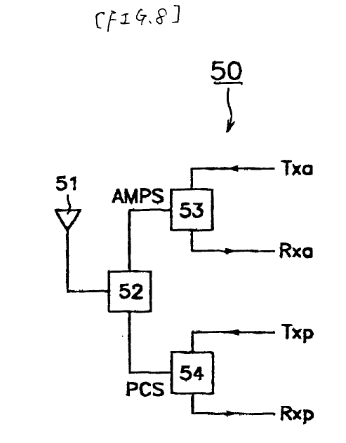

FIG. 7 is a circuit diagram of the high frequency filter constituting the high frequency composite component shown in FIG. 6. The high frequency filter 14 is constituted of an inductor L4a, and capacitors C4a and C4b.

Furthermore, an inductor L4a is connected between a first port P41 and a second port P42. The capacitor C4a is connected in parallel to the inductor L4a. The second port P42 of the inductor L4a is connected to a ground via the capacitor C4b.

With the above arrangement, the high frequency filter 14 defines a low pass filter including the inductor L4a and the capacitors C4a and C4b. The low pass filter permits the second harmonic and the third harmonic of the PCS system to be attenuated.

In the above high frequency composite component of the second preferred embodiment, since the high frequency filter is connected to the PCS system of the TDMA technique, the second harmonic and the third harmonic can be attenuated. As a result, the transmission/reception qualities of the TDMA-technique side can be improved.

Particularly, as shown in FIG. 6, in the case of the high frequency filter connected to the transmission section of the rear stage of the high frequency switch, when a signal is transmitted, the high frequency filter can attenuate distorted signals generated by a high power amplifier included in the transmission section. Thus, insertion losses on the reception-section side are greatly reduced.

In the above-described preferred embodiments, the high frequency composite component is used with the combination of the AMPS system and the PCS system. However, the present invention is not restricted to this combination. Any other combination is applicable as long as the combination of the CDMA technique and the TDMA technique is provided.

Furthermore, in the above-described preferred embodiments, the signal paths of two systems are provided. However, in this invention, the same advantages can be obtained in the cases of signal paths of three or more systems.

In addition, in each of the above-described preferred embodiments, the high frequency filter is preferably a low pass filter. However, either a band pass filter or a band elimination filter can be used to obtain the same advantages as long as the filter is capable of attenuating harmonics. Particularly, when a notch filter as one of band elimination filters is used, the signals of frequencies only near the second harmonic and the third harmonic to be attenuated can be attenuated. As a result, influence on a fundamental-frequency pass band can be reduced. Therefore, when compared with the cases of the low pass filter and the band pass filter in which the overall harmonic band is attenuated, insertion loss in the fundamental-frequency pass band can be more reduced. As a result, loss of the overall high frequency composite component can be reduced.

As described above, according to the high frequency composite component of the present invention, switching between transmission/reception of the PCS system of the TDMA technique is performed by the compact high frequency switch having fewer constituting elements than the duplexer. Thus, the high frequency composite component can be miniaturized.

In addition, the diplexer, the duplexer, and the high frequency switch are defined by a multi-layer substrate including a plurality of ceramic sheet layers that are laminated together. Thus, connections of the diplexer, the duplexer, and the high frequency switch are located inside of the multi-layer substrate. As a result, there is no need for a matching circuit to perform matching adjustments between the diplexer and the duplexer, and matching adjustments between the diplexer and the high frequency switch. Accordingly, further miniaturization of the high frequency composite component can be achieved.

Furthermore, the losses caused by wiring between elements can be reduced, since the diplexer and the duplexer are defined by inductors and capacitors and the high frequency switch includes diodes, inductors, and capacitors. In addition, the diplexer, the duplexer, and the high frequency switch are contained or mounted in the multi-layer substrate and connected to each other by connection units disposed inside of the multi-layer substrate. Thus, the loss of the overall high frequency composite component can also be reduced. Accordingly, at the same time, the mobile communication apparatus incorporating the high frequency composite component can obtain high performance capabilities.

In the above high frequency composite component of the second preferred embodiment, since the high frequency filter is connected to the PCS system of the TDMA technique, the second harmonic and the third harmonic can be attenuated. As a result, the transmission/reception qualities of the TDMA-technique side are greatly improved.

Furthermore, in the mobile communication apparatus of the present invention, since the compact high frequency composite component capable of reducing loss is incorporated therein, the mobile communication apparatus can be miniaturized and can obtain high performance capabilities.

While preferred embodiments of the present invention have been described, it is to be understood that modifications and variations will be apparent to those skilled in the art without departing from the spirit of the invention. The scope of the invention, therefore, is to be determined solely by the following claims.

What is claimed is:

1. A high frequency composite component, comprising:
a diplexer arranged to distribute a signal received via an antenna to a CDMA signal path or a TDMA signal path and to transmit a signal sent from the CDMA signal path or the TDMA signal path to the antenna;
a duplexer disposed in the rear stage of the diplexer to divide the CDMA signal path into a transmission section and a reception section; and
a high frequency switch disposed in the rear stage of the diplexer to divide the TDMA signal path into a transmission section and a reception section.

2. A high frequency composite component according to claim 1, wherein the diplexer, the duplexer and the high frequency switch are arranged to define a portion of a front-end section in a mobile communication apparatus for CDMA/TDMA systems.

3. A high frequency composite component according to claim 1, further comprising a high frequency filter, which is connected to at least one of a location between the diplexer and the high frequency switch, the transmission section in the rear stage of the high frequency switch, and the reception section in the rear stage of the high frequency switch.

4. A high frequency composite component according to claim 1, wherein at least one of the diplexer, the duplexer, and the high frequency switch is defined by a multi-layer substrate including a plurality of dielectric layers laminated.

5. A high frequency composite component according to claim 1, wherein each of the diplexer, the duplexer, and the high frequency switch is defined by a multi-layer substrate including a plurality of dielectric layers laminated.

6. A high frequency composite component according to claim 1, wherein each of the diplexer, the duplexer and the high frequency switch includes at least first, second and third ports, wherein the first port of the diplexer is connected to an antenna, the second port of the diplexer is connected to the first port of the duplexer, and the third port of the diplexer is connected to the first port of the high frequency switch.

7. A high frequency composite component according to claim 6, wherein the second port of the duplexer is connected to the transmission section, and the third port of the duplexer is connected to the reception section.

8. A high frequency composite component according to claim 6, wherein the second port of the high frequency switch is connected to the transmission section, and the third port of the high frequency switch is connected to the reception section.

9. A high frequency composite component according to claim 1, wherein the diplexer includes a plurality of inductors and a plurality of capacitors.

10. A high frequency composite component according to claim 1, wherein the diplexer includes first, second and third ports, a low pass filter is defined between the first port of the diplexer and the second port of the diplexer, and a high pass filter is provided between the first port of the diplexer and the third port of the diplexer.

11. A high frequency composite component according to claim 1, wherein the duplexer includes a plurality of inductors and a plurality of capacitors.

12. A high frequency composite component according to claim 1, wherein the duplexer includes first, second and third ports, a first resonator and a second resonator are provided between the first port of the duplexer and the second port of the duplexer.

13. A high frequency composite component according to claim 12, wherein a third resonator and a fourth resonator are provided between the first port of the duplexer and the third port of the duplexer.

14. A high frequency composite component according to claim 1, wherein the duplexer includes first, second and third ports, and band pass filters are provided between the first port of the duplexer and the second port of the duplexer, and between the first port of the duplexer and the third port of the duplexer.

15. A high frequency composite component according to claim 14, wherein the band pass filter provided between the first port of the duplexer and the second port of the duplexer is arranged to allow the passing of only signals transmitted from the transmission section.

16. A high frequency composite component according to claim 14, wherein the band pass filter provided between the first port of the duplexer and the third port of the duplexer is arranged to allow the passing of only signals received by the reception section.

17. A high frequency composite component according to claim 1, wherein the high frequency switch includes a plurality of diodes, a plurality of inductors, a plurality of capacitors and at least one resistor.

18. A high frequency composite component according to claim 1, wherein at least one of the inductors is a parallel trap coil and another of the inductors is a choke coil.

19. A high frequency composite component according to claim 1, wherein the diplexer, the duplexer, and the high frequency switch are contained in the multi-layer substrate and are connected to each other by connections provided inside the multi-layer substrate.

20. A mobile communication apparatus comprising:
an antenna;
a transmission section;
a reception section; and
a high frequency composite component according to claim 1.
